(19) United States
(12) Patent Application Publication
(10) Pub. No.: US 2014/0090967 A1
(43) Pub. Date: Apr. 3, 2014

(54) TWO-STEP SWITCH

(71) Applicant: Covac Co., Ltd., Saitama (JP)

(72) Inventor: Shuji Inagaki, Soka-shi (JP)

(73) Assignee: Covac Co., Ltd., Saitama (JP)

(21) Appl. No.: 14/115,508

(22) PCT Filed: Apr. 6, 2012
(86) PCT No.: PCT/JP2012/059473

§ 371 Date: Nov. 4, 2013

(30) Foreign Application Priority Data
May 10, 2011 (JP) 2011-104866

(51) Int. Cl. H01H 13/14

(52) U.S. Cl. CPC H01H 13/14
USPC 200/513

(57) ABSTRACT

[Problem]

To provide a two-stage switch which has few components, can be made thin, and can obtain a clear clicking sense.

[Solution]

A two-stage switch (10) is provided with a click dome plate (20) having a movable contact, a keypad (30) joined to the upper surface of the dome of the dome plate (20), and a fixed contact (41) formed on a substrate (40). The fixed contact (41) comprises a first stage fixed contact (42) and second stage fixed contact (43). When the keypad (30) is not being subjected to a pressing operation, the dome plate (20) is in a floating state without contacting any of the fixed contacts. With a first stage pressing operation on the keypad (30), the pad (30) is deformed and the dome plate (20) comes into contact with the first stage fixed contact (42). With a second stage pressing operation on the keypad (30), the dome plate (20) deforms with a clicking sensation and comes into contact with the second stage fixed contact (43).

### TECHNICAL FIELD

The present invention relates to a two-step switch. In particular, it relates to a two-step switch having less number of parts and adaptable to thinner construction.

### BACKGROUND ART

The two-step switch is a switch which carries out a first-step pressing operation and a second-step pressing operation subsequent thereto each of which carry out different contents of operations, and has been used for controlling an in-vehicle equipment such as a steering wheel, or a home electric appliance. For example, by the first-step pressing operation, the switch, or information or a display provided to the switch is illuminated so that the person can identify which switch has been pressed, and by the second-step pressing operation, an operation in accordance with the information or the display is carried out. Alternatively, by the first-step pressing operation, information about which switch has been pressed is shown at a display, etc., and by the second-step pressing operation, the displayed operation is carried out. In this case, the display is not necessarily working at all time, so that power saving is also possible.

In such a two-step switch, there are a push button switch, and a switch using a liquid crystal touch panel, etc. An example of the two-step switch is shown in FIG. 7.

A two-step switch 100 of this example is configured by a keypad 130 to which a push button part 131 to be subjected to pressing operation has been formed, a first switch part 140 provided at the downward of the push button part 131, an actuator 150 which is movably supported to the perpendicular direction at the downward of the first switch part 140, and a second switch part 160 provided at the downward of the actuator 150. The first switch part 140, the actuator 150 and the second switch part 160 are supported by a case 180 provided at an upper surface of a substrate 170. The case 180, the actuator 150, the first switch part 140 and the keypad 130 may be prepared by a transparent or semi-transparent material in some cases.

The first switch part 140 is a flexible substrate in this example, and the portion directly under the push button part 131 comprises an upper and lower two-layered structure sandwiching a space. The switch is ON by contacting the upper layer and the lower layer, and a lighting device 190 provided to the case 180 emits light. The second switch part 160 in this example is a usual switch, and by pressing the switch, various kinds of operations are performed.

An operation of the two-step switch 100 is explained. By the first-step pressing operation of the push button part 131, the two-layer structure part of the flexible substrate 140 is pressed downward, and the two-layer structure part is sandwiched by the lower surface of the push button part 131 and the upper surface of the actuator 150 at the downward thereof, to contact the upper and the lower layers to be the switch ON. According to this procedure, the lighting device 190 emits light. The light is irradiated outside through the case 180, the actuator 150 or the keypad 130. By the second-step pressing operation of the push button part 131, the second switch 160 is pressed through the flexible substrate 140 and the actuator, various kinds of operations are carried out.

By the way, as a switch which performs one step pressing operation, those using a click dome plate have been proposed (for example, see Patent Document 1). The peripheral line of the dome plate is contacted with the upper surface of the substrate. When the portion around the top area of the dome plate is pressed, the top portion of the dome plate is depressed by elastic deformation, and the portion around the top area is contacted with the contact point provided on the substrate. According to the elastic deformation of the dome plate, click feeling is generated.

For the other switch using a liquid crystal touch panel, a capacitance type or a pressure-sensitive type sensor is used. Various kinds of information are displayed at the panel, and when the portion displayed the desired information is pressed, then, the information is displayed at the panel. Further, when a predetermined portion is pressed, the operation related to the information is performed.

### PRIOR ART DOCUMENT

### Patent Document

[Patent Document 1] JP Hei.8-335424A

### DISCLOSURE OF THE INVENTION

### Problems to be Solved by the Invention

The two-step switch shown in FIG. 7 has relatively a large number of parts, and structurally requires a certain extent of the thickness. In addition, an expensive flexible substrate is used to make the switch thin. Moreover, when a lighting device is to be provided, it is impossible to arrange the lighting device at the portion directly under the push button part, so that it cannot help being arranged at the surrounding casing whereby sufficient illumination performance cannot be obtained.

Also, when a liquid crystal touch panel is used, it can also serve as a display for displaying information indicating which switch was pressed when the switch was set to ON. However, a clear operational feeling cannot be obtained when the switch is ON. Further, in the case of the capacitance type, there are cases where it does not operate properly when an electrostatic voltage has changed when hands are wet or with gloves, or a temperature has changed.

The present invention has been done in view of the above-mentioned points, and an object thereof is to provide a two-step switch which has few number of parts, which can be made thin and can obtain a clear click feeling.

### Means to Solve the Problems

The two-step switch of the present invention comprises a click dome plate having a movable contact, a keypad bonded at an upper surface of a dome of the dome plate, and a fixed contact opposed to the movable contact, wherein the fixed contact has a first-step fixed contact and a second-step fixed contact, and in a state where the keypad is not subjected to a pressing operation, the dome plate is in a floating state while being held by the pad without contacting any of the fixed contacts, a movable contact of the dome plate is contacted with the first-step fixed contact by deformation of the pad due to a first-step pressing operation of the keypad, and the movable contact of the dome plate is contacted with the second-step fixed contact by deformation of the dome plate accompanied by click feeling due to a second-step pressing operation of the keypad.

According to the present invention, necessary constitutional parts are at least three parts of a keypad, a dome plate and a substrate to which a fixed contact has been formed, so that a number of the parts can be reduced as compared with the general two-step switch of the conventional art. Further, it does not use any expensive flexible substrate, etc., so that it can be produced with an inexpensive cost. In addition, thicknesses of the respective parts are relatively thin, so that it can be made thin.

In this switch, by the first-step pressing operation, the keypad is deformed to conduct the first-step fixed contact. This pressing operation has a less degree of increasing a counterforce relative to the stroke. Thereafter, by the second-step pressing operation, the keypad is firstly compressed to the up-and-down direction. This operation can be made a degree of increasing the counterforce large. Then, when the counterforce reaches to the peak, the dome plate is dented to conduct the second-step fixed contact. This operation has a short stroke, the counterforce is abruptly decreased, and it can be made to generate click feeling. Thus, pressing characteristics of the first-step pressing operation and the second-step pressing operation can be made different, so that it can be clearly felt that each switch operation has been performed.

More specifically, a preliminary operation in which the switch has been pressed is displayed (a predetermined portion is lightened or the operation is displayed at a display, etc.) by a visually recognizable method, or notified by a sound, etc., may be carried out by the first-step pressing operation. Then, a main operation which is to perform the contents relating to the pressed switch can be carried out by the second-step pressing operation.

Further, since a dustproof function or watertight function can be added to the keypad, reliability of the switch can be heightened. Moreover, operability does not change even if the operation is carried out by wet fingers or with a hand wearing gloves. Furthermore, change in the temperature is irrelevant so that reliability is higher.

In the present invention, a preliminary operation may be performed by which an operator visually or aurally recognize that an operation is carried out by a first-step pressing operation of a keypad, and then, a main operation is performed by a second-step pressing operation of the keypad.

Incidentally, the main operation means an operation which is primarily performed by pressing the switch, and the preliminary operation means an operation preliminary performed to carry out the main operation. For example, in the case of the switch provided at the steering wheel as mentioned above, the preliminary operation is an operation displaying information showing which switch was pressed at the display of the front panel, and the main operation is a primary operation that performs the displayed contents.

In the present invention, a through hole is formed at the dome plate, or the dome plate is prepared from a transparent or semi-transparent material, the keypad is prepared from a transparent or semi-transparent material, and a light source is arranged at the downward of the dome plate.

According to the present invention, when a light source is emitted light by the first-step pressing operation, the light is irradiated through the keypad by passing a through hole of the dome plate if the through hole is formed to the dome plate, or transmitting the dome plate if the dome plate is prepared by a transparent or semi-transparent material. Also, if the position of the pressing portion and the position of the light-emitting portion are differentiated, it is possible to illuminate the portion different from the portion pressed by a finger. Or else, if a light shielding film is formed at the upper surface of the keypad prepared by a transparent or semi-transparent material, and a part of a letter or a pattern to want to pass the light is clipped by a laser, the letter or the pattern can be seen with shine. Thus, a variety of lightings can be achieved.

In the present invention, a plural number of sheets of the dome plates are joined to a sheet of the keypad, so that a plural number of the switch portions can be formed.

According to the present invention, a plural number of the switch portions can be provided to a sheet of the keypad, so that a simple appearance can be realized. Also, the keypad can be commonly used, so that the cost can be reduced. Moreover, there is no gap or slit between the switches so that waterproofing property or dust resistance can be obtained.

### Effects of the Invention

As can be clearly seen from the above explanation, necessary constitutional parts of the two-step switch of the present invention is at least three, a keypad, a dome plate and a substrate to which a fixed contact has been formed, so that a number of the parts is small as compared with those of the general two-step switches of the conventional art. Further, an expensive flexible substrate, etc., is not used so that it can be manufactured inexpensively. Moreover, a thickness of each part is relatively thin, so that it can be made thin.

### BRIEF DESCRIPTION OF THE DRAWINGS

FIG. 1 is a drawing showing the two-step switch according to the first embodiment of the present invention, where FIG. 1(A) is a side sectional view of the two-step switch, and FIG. 1(B) is a plane view of the fixed contact.

FIG. 2 is a plane view showing the touch panel equipped with the two-step switch of FIG. 1.

FIG. 3 is a drawing showing the switch operations of the two-step switch of FIG. 1.

FIG. 4 is a graph showing the relation between a stroke and a counterforce in the switch operation of FIG. 3.

FIG. 5 is a side sectional view showing the two-step switches according to the second embodiment of the present invention.

FIG. 6 is a drawing showing modified examples of the two-step switch of the present invention.

FIG. 7 is a drawing showing an example of the conventional two-step switch.

### EMBODIMENTS TO CARRY OUT THE INVENTION

In the following, embodiments of the present invention are explained in detail by referring to the drawings.

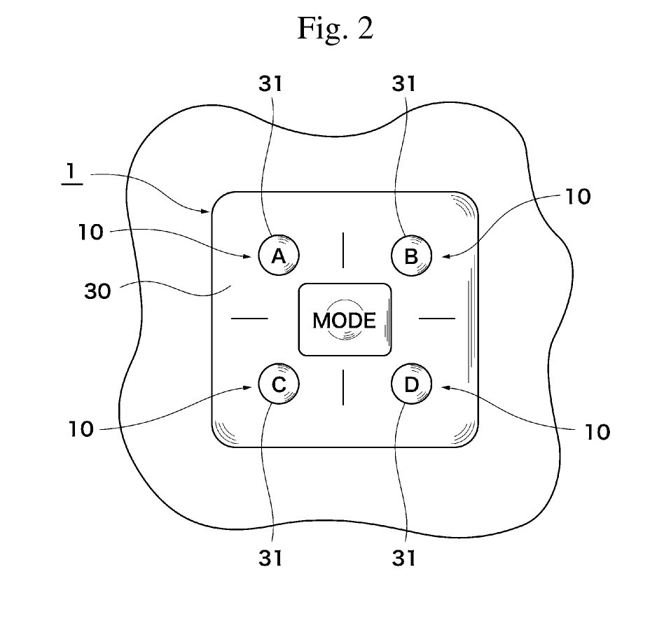

First, by referring to FIG. 2, a touch panel equipped with a two-step switch according to the first embodiment of the present invention is explained.

A touch panel 1 in this example is of a type showing information displaying which switch was pressed is displayed by the first-step pressing at a display etc., provided at a place different from that of the panel, and the displayed operation is carried out by the second-step pressing. As a specific example, the switch is provided at a control panel on a steering wheel, information showing which switch was pressed is displayed at the display of the front panel by the first-step pressing, and the displayed operations are carried out by the second-step pressing.

In this example, the touch panel 1 is to select one mode from four modes of A, B, C and D. Each of the portions printed as “A”, “B”, “C” and “D” of the panel forms the two-step switch 10. For example, if the portion printed as “A” is pressed as the first-step pressing operation, it is displayed as “mode A” at the display of the front panel. Then, if the second-step pressing operation is performed, click feeling can be obtained as well as the operation of “mode A” is carried out.

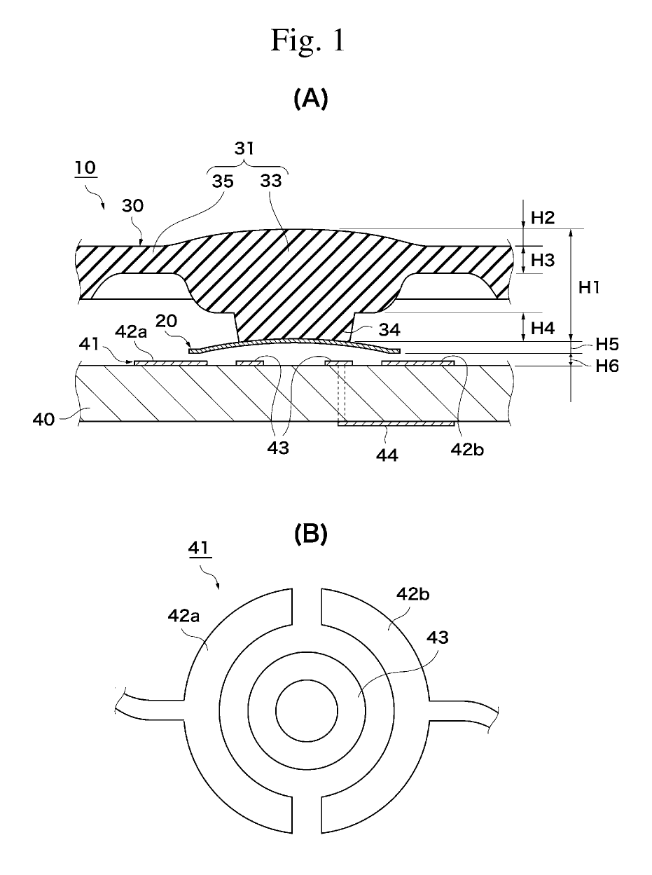

By referring to FIG. 1, the two-step switch according to the embodiment of the present invention is explained.

The two-step switch 10 has a click dome plate 20, a keypad 30, and a fixed contact 41 formed on a substrate 40.

The dome plate 20 has a thin dome-like shape with a planar shape of which is a circle. The dome plate 20 is prepared by a material which is dented by elastic deformation when the upper surface (for example, in the vicinity of the vertex) of the dome is pressed, and recovers the original shape when released it. At the time of the elastic deformation, click feeling is given to the user. Such a material may be a plate (as an example, in the case of made of a metal, for example, stainless steel or a copper alloy (phosphor bronze), etc. a thickness of 40 μm to 75 μm, in the case of made of a plastic for example, PET or PC, etc., a thickness of 75 μm to 125 μm), The dome plate 20 can be prepared by forming such a plate to a dome shape.

When the dome plate 20 is prepared by a metal plate, the whole surface of the lower surface (the surface opposing to the fixed contact) of the dome plate 20 becomes a movable contact. Also, when it is prepared by a plastic, a movable contact is formed by printing a conductive ink at the whole surface of the lower surface, or, two portions of the lower surface at which two kinds of the fixed contacts 41 (details are mentioned below) formed on the upper surface of the substrate 40 are contacted at the time of elastic deformation.

The keypad 30 is a sheet state member, and prepared by a material having elasticity (for example, silicon rubber or an elastomer), etc. In the case of the touch panel shown in FIG. 2, a sheet of the keypad 30 is commonly used for all the two-step switches 10. The keypad 30 is, as mentioned above, fitted in a window opened to a case or a board (steering wheel), and the outer peripheral portion is fixed at the back surface of the peripheral portion of the window.

At a predetermined portion of the keypad 30, a push button part 31 has been formed. The push button part 31 has a thick center portion 33, and a thin portion (which may be a skirt shape providing the click feeling) 35 around thereof. The upper surface of the center portion 33 is a gently sloped protruded shape, and a letter “A” (or “B”, “C” or “D”) has been printed on the surface thereof (see FIG. 2). At the center of the lower surface of the center portion 33, a projected portion 34 which is projected downward has been formed. To the projected portion 34 is joined the portion in the vicinity of the vertex of the upper surface of the dome plate 20 by an adhesive, etc.

The substrate 40 is, for example, a PCB substrate both surfaced of which have been printed printed-circuits, and provided at the downward of the keypad 30. In this construction, there is a distance between the dome plate 20 joined to the push button part 31 of the keypad 30 and the upper surface of the substrate 40, and any portion of the dome plate 20 is not contacted to the substrate 40.

At the upper surface of the substrate 40, a fixed contact 41 is formed. The fixed contact 41 has, as shown in FIG. 1(B), a first-step fixed contact 42 at an outer peripheral, and a second-step fixed contact 43 at the center thereof.

The first-step fixed contact 42 is so provided that it is opposed to the outer peripheral portion of the dome plate 20. The fixed contact 42 has two half-split portions 42a and 42b in which the ring has been half split. Each half-split portion is connected with the respective circuits at the upper surface of the substrate 40.

The second-step fixed contact 43 is so provided in a ring shape that it is opposed to the outer peripheral portion of the lower projected portion 34 of the push button part 33 of the keypad 30. The fixed contact 43 is connected with a circuit 44 at the back surface by penetrating the substrate 40.

Examples of the size of each portion are explained.

A thickness H1 of the center portion 33 of the push button part 31: 3.3 mm,

a height H2 of the projected portion at the upper surface of the push button part 31: 0.5 mm,

a thickness H3 of the thin portion 35 of the push button part 31: 0.8 mm,

a height H4 of the lower projected portion 34 of the push button part 31: 0.8 mm,

a height H5 of the dome plate 20: 0.35 mm, and

a distance H6 between the lowermost portion of the dome plate 20 and the upper surface of the substrate 40: 0.4 mm

In this case, the height of the switch (the height from the upper surface of the substrate 40 to the outermost surface of the push button part 31) is 4.05 mm Incidentally, the distance H6 between the lowermost portion of the dome plate 20 and the upper surface of the substrate 40 is adjustable.

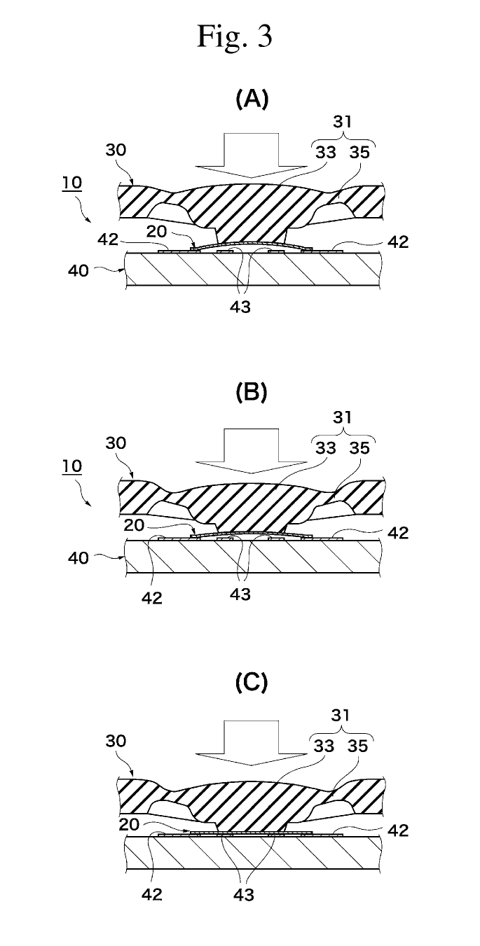

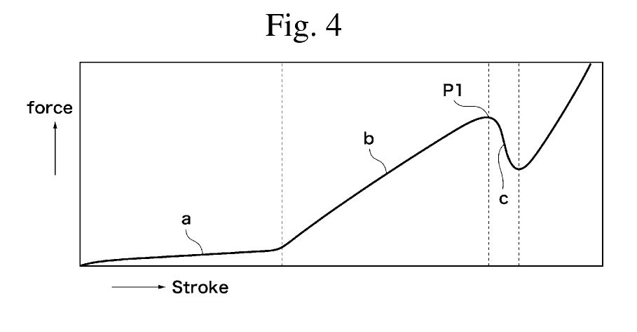

The operation of the switch is explained by referring to FIG. 3. A relationship between a stroke and a load (counterforce) applied to the push button part at the time of the pressing operation of the switch is simultaneously explained by referring to FIG. 4. In the graph of the drawing, the vertical axis shows a load (counterforce), and the lateral axis shows a stroke.

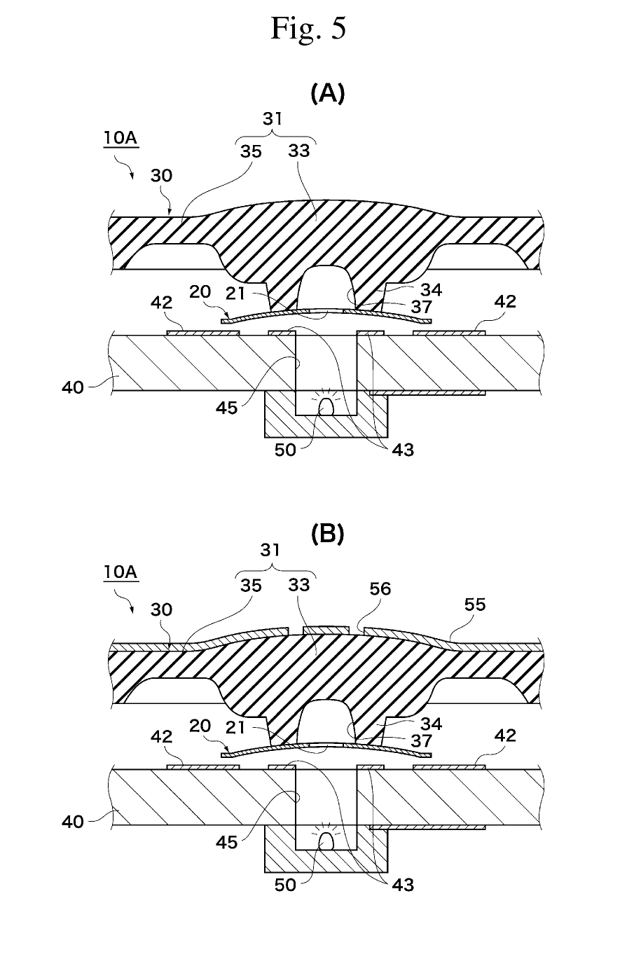

In a suspended state shown in FIG. 1(A), when the center portion 33 of the push button part 31 of the keypad 30 is pressed by the first-step pressing operation, the thin portion 35 at the peripheral thereof is deformed to go down the center portion 33 as shown in FIG. 3(A), and the outer peripheral portion of the dome plate 20 is firstly contacted with the first-step fixed contact 42 of the substrate 40. According to this procedure, each half-split portion 42a, 42b of the first-step fixed contact 42 is conducted through the dome plate 20 and the first operation is performed. For example, “Mode A” is shown at the display mounted on the front panel. At this time, as shown at the portion “a” of the graph of FIG. 5, an increased degree of the counterforce is low relative to that of the stroke. The length of the stroke can be changed by adjusting the distance H6 between the lowermost portion of the dome plate 20 and the upper surface of the substrate 40 in FIG. 1(A).

Next, the center portion 33 is further pressed by the second-step pressing operation, the center portion 33 is compressed to the perpendicular direction as shown in FIG. 3(B). During this time, the counterforce is slightly abruptly increased as shown at the portion “b” of the graph of FIG. 4.

When the counterforce reaches to the peak P1, the dome plate 20 is elastic deformed to be dented to a substantially flat posture as shown in FIG. 3(C). At this time, the stroke is short and the counterforce is abruptly decreased as shown at the portion “c” of the graph of FIG. 4. According to abrupt decrease of the counterforce, click feeling is generated. The center portion of the dome plate 20 is simultaneously contacted with the second-step fixed contact 43 of the substrate 40 as shown in FIG. 3(C). According to this procedure, the second-step fixed contact 42 and the first-step fixed contact 43 are conducted through the dome plate 20 and the second operation is performed. For example, the contents of “mode A” are performed.

When the pressing of the center portion 33 of the push button part 31 is cancelled, the push button part 31 and the dome plate 20 return to the original posture.

The merits of this switch are shown below.

(1) A number of the parts are basically three, the keypad 30, the dome plate 20 and the substrate 40, and no expensive flexible substrate, etc., is used so that it can be prepared inexpensively. Further, it can be made thin.

(2) Due to deformation of the dome plate 20, clear click feeling can be obtained.

(3) A letter or a figure can be printed on the surface of the keypad 30, and it is not necessary to use an exterior panel, etc., additionally, so that it is possible to reduce a number of the parts or make the switch thin.

(4) A plural number of the switches can be constituted by a sheet of the keypad 30. In this case, no gap or step is generated between the switches, so that they have dust preventive and waterproof functions.

(5) When unevenness is provided at the surface of the keypad 30, touch typing can be carried out. Especially, when it is mounted on the controlling panel of the steering wheel, a driver can difficultly view one's hand so that it is displayed at a front panel provided at the position easily viewed the contents by the driver by touch typing, whereby the driver can be easily confirmed the contents.

(6) A first-step pressing operation can be performed with a relatively light touch.

The two-step switch according to the second embodiment of the present invention is explained by referring to FIG. 5.

The switch 10A of this example is applied to a touch panel of a type in which the switch, or information or a display provided to the switch emits light so that which switch has been pressed can be understood by the first-step pressing operation, and the operation followed by the information or the display is performed by the second-step pressing operation.

The switch 10A in this example is also constituted by the keypad 30, the dome plate 20 and the substrate 40 similarly as in the switch 10 of FIG. 1. Only different points from the respective parts of FIG. 1 are explained.

The dome plate 20 has a similar structure as that of the dome plate of the switch shown in FIG. 1, but an opening 21 is provided at the center thereof. Incidentally, when the dome plate 20 can be prepared by a transparent or semi-transparent material, the opening 21 may not necessarily be provided.

The keypad 30 is also the same as the keypad of the switch shown in FIG. 1, but a hole portion 37 with a certain degree of a depth is formed at the center of a lower projected portion 34 of a push button part 31. The keypad 30 is prepared by a transparent or an opaque material. The dome plate 20 is adhered to the bottom surface of the ring shaped portion at around the hole portion 37.

Further, a throughhole 45 is opened at the position of the substrate 40 opposed to the center of the lower projected portion 34 of the push button part 31 of the keypad 30. And a lighting device such as an LED lamp 50, etc., is attached at the downward of the throughhole 45. The LED lamp 50 is connected to the first-step fixed contact 42, and it is illuminated when the fixed contact 42 is conducted.

The operation of the switch 10A shown in FIG. 5(A) is explained.

When the center portion 33 of the push button part 31 of the keypad 30 is pressed by the first-step pressing operation, the center portion 33 goes down, and the outer peripheral portion of the dome plate 20 is contacted with the first-step fixed contact 42 of the substrate 40 similarly to the above-mentioned example. According to this procedure, each half-split portion of the first-step fixed contact 42 is conducted through the dome plate 20, and the LED lamp 50 emits light. The emitted light passes through a through hole 45 of the substrate 40, and an opening 21 of the dome plate 20 to enter into the hole portion 37 formed at the push button part 31 of the keypad 30 to make the push button part 31 illuminated. Next, when the center portion 33 is further pressed by the second-step pressing operation, the lower projected portion 34 presses the dome plate 20 against the substrate 40, and the dome plate 20 deforms to substantially flat posture. According to this procedure, the second-step fixed contact 42 and the first-step fixed contact 43 are conducted through the dome plate and the second operation is performed.

In the switch 10A shown in FIG. 5(B), a film 55 having a light-shielding property is coated onto the upper surface of the keypad 30. And a shape of a letter (for example, “A” or “B” of the panel of FIG. 2) or a pattern to be lighten is clipped to the film 55 of the upper surface of the push button part 33 by a marking laser, etc. The clipped portion is shown by the reference numeral 56. In this case, the light emitted from the LED lamp 50 is irradiated upward from the clipped portion 56, and the letter or the pattern can be viewed with shining.

The switch 10A of this example has the following merits in addition to the merits of the switch shown in FIG. 1.

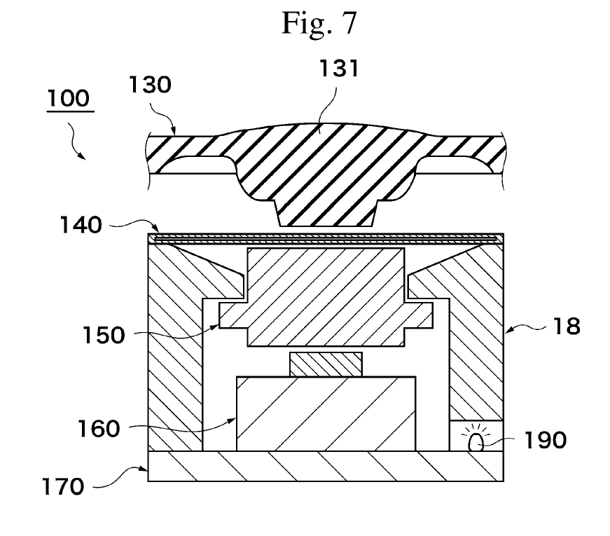

In the switch of the conventional example explained in FIG. 7, a lighting device 190 was necessarily arranged at the side of a push button part 131, so that there is a case where the light can be difficultly seen from the outside. On the other hand, in the switch 10A of this example, a lighting device 50 is arranged at directly under a center portion 33 of a push button part 31, so that the light is introduced through the push button part 31. Incidentally, the center portion 33 of the push button part 31 is in fact pushed by a finger and the finger shields the illumination, so that the locations of the lighting device 50 and the center portion 33 of the push button part 31 may be shifted.

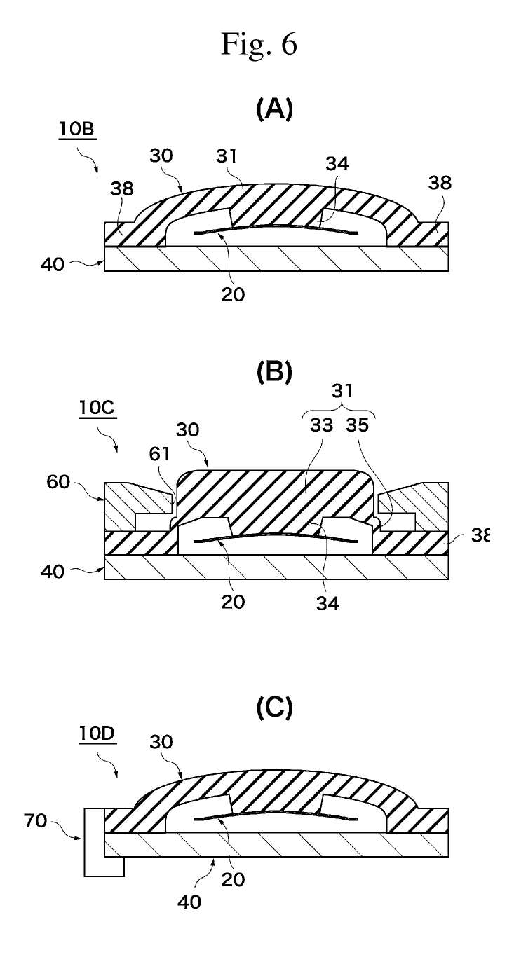

Next, a modified example of the two-step switch of the present invention is explained by referring to FIG. 6.

The switch 10B of FIG. 6(A) is of a type in which one push button part is provided to a sheet of a keypad 30. The keypad 30 of this switch has a push button part 31 the upper surface of which is pressed, and a base portion 38 to be joined to a substrate 40. The push button part 31 is formed to a dome shape with substantially the same thickness, and a lower projected portion 34 projected downward is formed at the center of the lower surface. A dome plate 20 is adhered to the projected portion 34. The base portion 38 is joined to the upper surface of the substrate 40.

The switch 10C of FIG. 6(B) is of a type to be incorporated into an exterior case 60. A keypad 30 of this switch has a push button part 31 the upper surface of which is pressed, and a base portion 38 to be joined to a substrate 40. The push button part 31 has a center portion 33, and a thin portion (skirt portion) 35 which is to support the center portion 33 to the base portion 38. The center portion 33 has a flat rectangular parallelepiped shape, and a projected portion 34 projected downward is formed at the center of the lower surface. A dome plate 20 is adhered to the projected portion 34.

At an exterior case 60, an opening 61 from which the push button part 31 is exposed is opened.

The switch 10D of FIG. 6(C) has a similar structure to that of the switch 10B of FIG. 6(A), and a side edge surface of a keypad 30 and a side edge surface of a substrate 40 are made fluid-tight by a seal 70. According to this constitution, water-proof function can be obtained.

EXPLANATION OF REFERENCE NUMERALS

| | | | |
|---|---|---|---|
| 1 | Touch panel | 10 | Two-step switch |
| 20 | Click dome plate (Dome plate) | 21 | Opening |
| 30 | Keypad | 31 | Push button part |
| 33 | Center portion | 35 | Thin portion |
| 34 | Lower projected portion | 38 | Base portion |
| 40 | Substrate | 41 | Fixed contact |
| 42 | First-step fixed contact | 43 | Second-step fixed contact |
| 44 | Circuit | 45 | Through hole |
| 50 | LED lamp | 60 | Exterior case |
| 61 | Opening | 70 | Seal |

1. A two-step switch comprising
a click dome plate having a movable contact,
a keypad joined at an upper surface of the dome of the dome plate, and
a fixed contact opposing to the movable contact,
wherein the fixed contact has a first-step fixed contact and a second-step fixed contact, and
in a state where the keypad is not subjected to a pressing operation, the dome plate is in a floating state while being held by the pad without contacting any of the fixed contacts,
a movable contact of the dome plate is contacted with the first-step fixed contact by deformation of the pad due to a first-step pressing operation of the keypad, and
the movable contact of the dome plate is contacted with the second-step fixed contact by deformation of the dome plate accompanied by click feeling due to a second-step pressing operation of the keypad.

2. A two-step switch wherein
a preliminary operation by which an operator visually or aurally recognize that an operation is carried out by a first-step pressing operation of a keypad, and then,
a main operation is carried out by a second-step pressing operation of the keypad.

3. The two-step switch according to claim 1, wherein
a through hole is formed at the dome plate, or the dome plate is prepared from a transparent or semi-transparent material,
the keypad is prepared from a transparent or semi-transparent material, and
a light source is arranged at downward of the dome plate.

4. The two-step switch according to claim 1, wherein
a plural number of sheets of the dome plates are joined to a sheet of the keypad, and a plural number of switch portions are formed.

5. The two-step switch according to claim 2, wherein
a through hole is formed at the dome plate, or the dome plate is prepared from a transparent or semi-transparent material,
the keypad is prepared from a transparent or semi-transparent material, and
a light source is arranged at downward of the dome plate.

6. The two-step switch according to claim 2, wherein
a plural number of sheets of the dome plates are joined to a sheet of the keypad, and a plural number of switch portions are formed.

7. The two-step switch according to claim 3, wherein
a plural number of sheets of the dome plates are joined to a sheet of the keypad, and a plural number of switch portions are formed.

8. The two-step switch according to claim 5, wherein
a plural number of sheets of the dome plates are joined to a sheet of the keypad, and a plural number of switch portions are formed.
